(19) United States
(12) Patent Application Publication
(10) Pub. No.: US 2011/0047020 A1
(43) Pub. Date: Feb. 24, 2011

(54) SALES DATA PROCESSING APPARATUS AND SALES DATA PROCESSING METHOD

(75) Inventor: Yoshitaka Iwazaki, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/841,272

(22) Filed: Jul. 22, 2010

(30) Foreign Application Priority Data
Aug. 21, 2009 (JP) 2009-191981

(51) Int. Cl. G06Q 30/00; G06F 17/00

(52) U.S. Cl. 705/14.33; 235/375

(57) ABSTRACT

A sales data processing apparatus includes a member rank accepting unit, a point accepting unit, an extraction unit, and a calculation unit. The member rank accepting unit accepts an input of a member rank of a customer as of when a point voucher is used. The point accepting unit accepts an input of a number of points on the point voucher. The extraction unit extracts, from a storage unit which stores a point return rate defining how much should be returned in dollars for one point corresponding to a member rank, the point return rate corresponding to the member rank accepted by the member rank accepting unit. The calculation unit calculates an amount of return on the point voucher on the basis of the number of points accepted by the point accepting unit and the point return rate extracted by the extraction unit.

### FIELD

Embodiments described herein relate generally to a sales data processing apparatus and a sales data processing method.

### BACKGROUND

Conventionally, a system is broadly used in which points are given to customers according to the amount of purchase or the like and a point voucher is issued with which the customers can have a discount according to the accumulated points, in order to improve customer attraction and increase the number of regular customers. Moreover, recently, a technique relating to a POS (point of sales) system is disclosed in which ranks of customers are set according to the cumulative amount of purchase by the customer, the number of visits to the store by the customer and the like and then points are given according to the ranks, in order to differentiate services for regular customers.

However, conventionally, at the time of giving points, the points to be given are calculated according to the member rank and the amount of return on an issued point voucher is fixed when the voucher is issued. Therefore, even if the member is raised after the point voucher is issued, the amount of return on the point voucher is fixed and the customer feels no need to increase the cumulative amount of purchase in particular. Thus, there is a problem that it is difficult to increase consumer appetite immediately after the point voucher is issued.

### BRIEF DESCRIPTION OF THE DRAWINGS

FIG. 1 is a plan view showing an example of a point voucher.

FIG. 2 is an outer perspective view showing the configuration of a POS terminal according to an embodiment.

FIG. 3 shows magnetic information on a member card.

FIG. 4 is a block diagram showing the functional configuration of the POS terminal.

FIG. 5 illustrates a return rate setting table.

FIG. 6 is a flowchart illustrating procedures to calculate the amount of return on the point voucher.

FIG. 7 is a plan view showing an example of a point voucher used in a second embodiment.

FIG. 8 is a block diagram showing the functional configuration of the POS terminal.

FIG. 9 is a flowchart illustrating procedures to calculate the amount of return on the point voucher.

### DETAILED DESCRIPTION

According to an embodiment, a sales data processing apparatus includes a member rank accepting unit, a point accepting unit, an extraction unit, and a calculation unit. The member rank accepting unit accepts an input of a member rank of a customer as of when a point voucher is used. The point accepting unit accepts an input of a number of points on the point voucher. The extraction unit extracts, from a storage unit which stores a point return rate defining how much should be returned in dollars for one point corresponding to a member rank, the point return rate corresponding to the member rank accepted by the member rank accepting unit. The calculation unit calculates an amount of return on the point voucher on the basis of the number of points accepted by the point accepting unit and the point return rate extracted by the extraction unit.

According to another embodiment, a sales data processing method includes, in a sale data processing apparatus, a member rank accepting unit accepting an input of a member rank of a customer as of when a point voucher is used, a point accepting unit accepting an input of a number of points on the point voucher, an extraction unit extracting, from a storage unit which stores a point return rate defining how much should be returned in dollars for one point corresponding to a member rank, the point return rate corresponding to the member rank accepted by the member rank accepting unit, and a calculation unit calculating an amount of return on the point voucher on the basis of the number of points accepted by the point accepting unit and the point return rate extracted by the extraction unit.

### First Embodiment

In this embodiment, a case of applying a sales data processing apparatus to a POS terminal used in a store like a supermarket will be described.

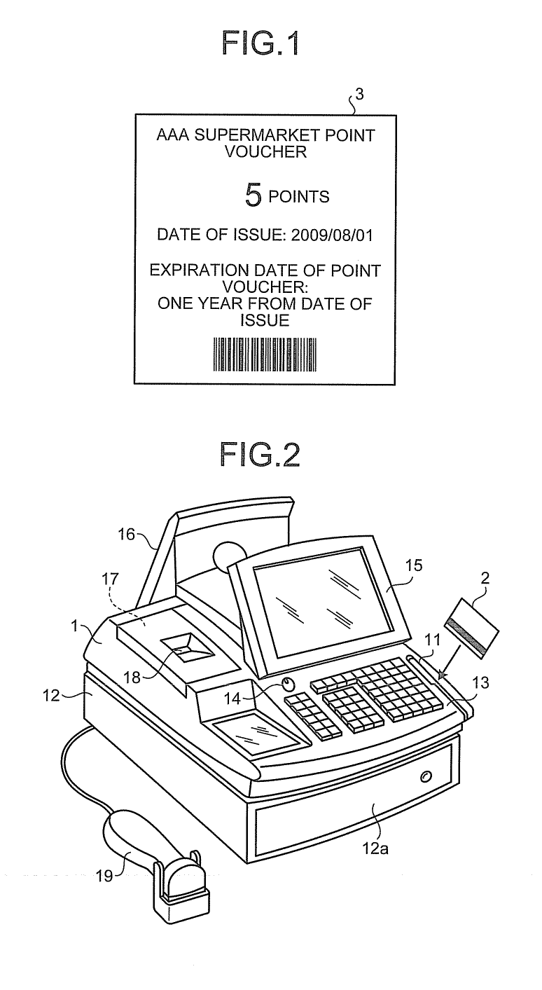

First, points are given to a member customer according to the amount of purchase when the member purchases an article. For example, the number of points given is accumulated and stored on a member card 2 of the customer (see FIG. 2). If a predetermined number of points is reached, a point voucher 3 (see FIG. 1) having the predetermined number of points (in FIG. 1, 5 points) is issued from the POS terminal or a point voucher issue machine in the store. FIG. 1 is a plan view showing an example of the point voucher 3. As shown in FIG. 1, the name of the store where the point voucher 3 is issued or the name of the point voucher 3, the number of points, the date of issue and the expiration date of the point voucher 3 and the like are described on the point voucher 3, and a code symbol such as a barcode or two-dimensional code storing such information is provided.

The customer can use the point voucher 3 thus issued, as a discount voucher when purchasing an article in the store where the point voucher 3 is issued or an affiliated stored of that store. For example, by presenting the point voucher 3 with 5 points as shown in FIG. 1 at the time of checkout, the customer can have a discount of an amount equivalent to 5 points from the total amount of purchase. Normally, in a store like a supermarket, point conversion is carried out only with a predetermined multiplication factor, such as one point being equivalent to one dollar, and no particular calculation is made. On the other hand, a POS terminal 1 in this embodiment enables change in the multiplication factor for point conversion when the customer uses the point voucher 3.

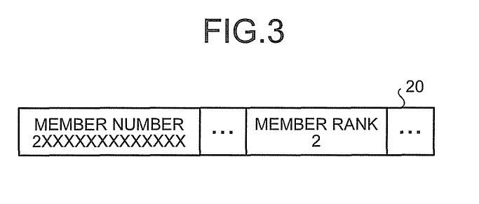

FIG. 2 is an outer perspective view schematically showing the configuration of the POS terminal 1 according to this embodiment. The POS terminal 1 is placed on a drawer unit 12 for housing cash or the like and controls the opening and closing of a drawer 12a of the drawer unit 12. On the front side of the POS terminal 1, a mode key 14 is provided to select various operation modes including registration, inspection, checkout and setting. On a keyboard 13 provided on the front of the POS terminal 1, operation keys are arranged for the operator (store clerk) to carry out various operation inputs, such as numeric keys to input, for example, a deposit amount, and a subtotal key to designate a total output of articles that are registered for sales in one transaction. At a position close to the keyboard 13, a card reader 11 is provided which reads member information including the member number of a customer and the member rank of the customer, which will be described later, from magnetic information 20 (see FIG. 3) on the member card 2 of the customer.

Here, member information stored on the member card 2 will be described with reference to FIG. 3. As shown in FIG. 3, the magnetic information 20 on the member card 2 stores member information including the member number which identifies the customer, the member rank and the like. The member rank refers to a rank that is set by the store for each member in accordance with predetermined standards such as the purchase record (total amount of purchase) by each customer (member), the number of visits to the store or the frequency of visiting the store, and the number of items purchased. As an example, the member rank is set to rank 1 at the time of admission, rank 2 for a member having the total amount of purchase of 500 dollars or more, and rank 3 for a member having the total amount of purchase of 1000 dollars or more.

Back to FIG. 2, a scanner 19 to scan a barcode attached to an article or the point voucher 3 is connected to the POS terminal 1. A clerk-side display 15 is attached to the front side of the POS terminal 1. A customer-side display 16 is attached to the back side of the POS terminal 1. The clerk-side display 15 and the customer-side display 16 display the item name and the price of an article that is registered for sales, the total amount in one transaction on which the end of sales registration is declared, the amount of change and the like. A liquid crystal color display or the like is used for these displays. The POS terminal 1 also includes a printer 17 which prints receipts, journals, and point vouchers. The receipts, journals, and point vouchers printed by the printer 17 are issued from a receipt issue port 18 formed on the front side of the POS terminal 1.

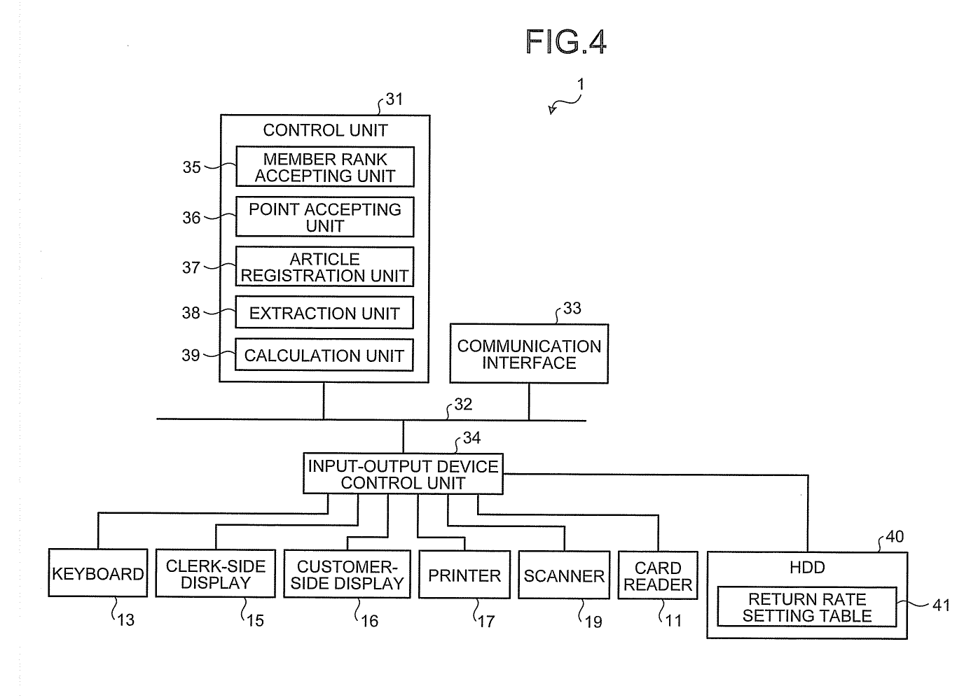

FIG. 4 is a block diagram showing the configuration of an electric system of the POS terminal 1. The POS terminal 1 has a control unit 31 having a computer configuration including a CPU (central processing unit), a ROM (read only memory) and a RAM (random access memory) functioning as storage units, (neither of which is shown) and the like. The ROM stores various programs to be executed by the CPU and various data. The RAM temporarily stores data and programs when the CPU executes various programs. The RAM also stores sales data representing sales records of articles and various screen display data to be displayed on the clerk-side display 15 and the customer-side display 16.

The control unit 31 controls input and output devices such as the keyboard 13, the clerk-side display 15, the customer-side display 16, the printer 17, the scanner 19, the card reader 11 and an HDD 40 via an input-output device control unit 34 and a bus 32, and controls the entire system of the POS terminal 1. The control unit 31 also can mutually communicate with a store server (not shown) connected by a LAN (local area network) via a communication interface 33. As the POS terminal 1 in this embodiment, a single POS terminal 1 may carry out article registration, article sales registration and the like on its own. Alternatively, if plural POS terminals 1 are installed in the store, a store server may be connected to the plural POS terminals 1 to collectively manage the processing such as article registration and article sales registration.

Here, the HDD 40 functions as a storage unit and stores a return rate setting table 41 in addition to various programs to be executed by the CPU.

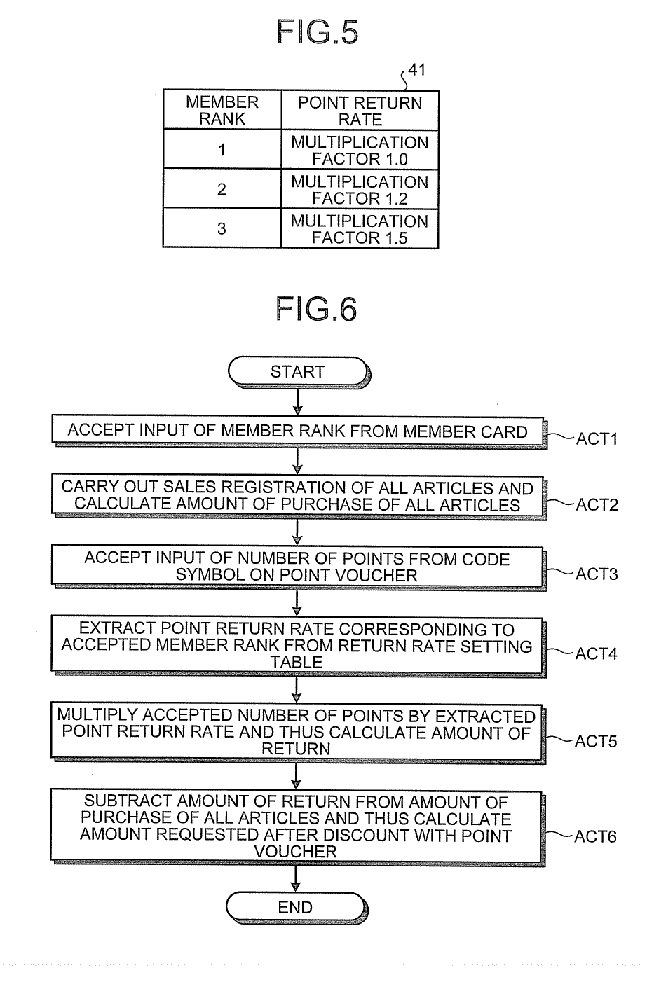

In the return rate setting table 41, a point return rate indicating how much should be returned in dollars for one point when a point voucher is used is set corresponding to each member rank. Specifically, the point return rate is set as follows, as shown in FIG. 5. That is, for member rank 1, the point return rate is a multiplication factor of 1.0 and one dollar is returned for one point. For member rank 2, the point return rate is a multiplication factor of 1.2 and 1.2 dollars is returned for one point. For member rank 3, the point return rate is a multiplication factor of 1.5 and 1.5 dollars is returned for one point.

Next, the functions of the control unit 31 will be described. As shown in FIG. 4, the control unit 31 mainly has a member rank accepting unit 35, a point accepting unit 36, an article registration unit 37, an extraction unit 38, and a calculation unit 39.

The member rank accepting unit 35 accepts an input of a member rank as of when the point voucher 3 is used. That is, when a customer uses the point voucher 3, a store clerk uses the card reader 11 to read the magnetic information 20 (see FIG. 3) on the member card 2 of the customer. The member rank accepting unit 35 accepts an input of the member rank as of when the point voucher 3 is used, from the magnetic information 20 that is read. For example, the member rank accepting unit 35 accepts an input that the member rank of the customer is 2 from the magnetic information 20 on the member card 2 shown in FIG. 3.

The point accepting unit 36 accepts an input of the number of points. That is, the store clerk uses the scanner 19 to scan a code symbol such as a barcode (see FIG. 1) or two-dimensional code on the point voucher 3 received from the customer. The point accepting unit 36 accepts the input of the number of points on the point voucher 3 from the code symbol that is read. The store clerk may also input the number of points described on the point voucher 3 via the keyboard 13 so that the point accepting unit 36 accepts the input of the number of points. As an example, as the scanner 19 scans the code symbol on the point voucher 3 shown in FIG. 1, the point accepting unit 36 accepts an input that the number of points is 500.

The article registration unit 37 accepts an input of the article code and article price from the code symbol as the barcode attached to an article is scanned by the scanner 19. Alternatively, the article registration unit 37 accepts the article code and article price inputted from the keyboard 13. Thus, the article registration unit 37 carries out sales registration of the article and calculates the amount of purchase of all the articles.

The extraction unit 38 extracts the point return rate corresponding to the member rank accepted by the member rank accepting unit 35, from the return rate setting table 41 (see FIG. 5). As an example, if the member rank accepting unit 35 accepts an input that the member rank is 2, the extraction unit 38 extracts information that the point return rate for member rank 2 is the multiplication factor of 1.2, from the return rate setting table 41 shown in FIG. 5.

The calculation unit 39 multiplies the number of points accepted by the point accepting unit 36 by the point return rate extracted by the extraction unit 38 and thus calculates the amount of return on the point voucher 3, as expressed by the following equation (1).

Amount of return on point voucher=number of points×point return rate (1)

To calculate the amount of return, the right side of equation (1) may be multiplied by an appropriate constant or variable.

Specifically, if the point accepting unit 36 accepts the input that the number of points is 5 points as described above and the extraction unit 38 extracts the information that the point return rate for member rank 2 is the multiplication factor of 1.2 as described above, the calculation unit 39 calculates the amount of return on the point voucher 3 as 5 points×1.2=6 dollars according to the above equation (1).

Then, the calculation unit 39 subtracts the amount of return on the point voucher 3 calculated as described above, from the amount of purchase of all the articles calculated by the article registration unit 37, and thus calculates the amount requested after the discount with the point voucher 3. For example, if the amount of purchase of all the articles is 20 dollars, the calculation unit 39 subtracts the amount of return 6 dollars calculated as described above, from 20 dollars, and thus calculates the amount requested 14 dollars after the discount.

Next, the procedures to calculate the amount of return on the point voucher 3 will be described. FIG. 6 is a flowchart illustrating the procedures to calculate the amount of return on the point voucher 3, carried out by the POS terminal 1.

First, as the clerk uses the card reader 11 to read the magnetic information 20 (see FIG. 3) on the member card 2, the member rank accepting unit 35 accepts an input of the member rank from the magnetic information 20 that is read (ACT 1).

Next, as the clerk uses the scanner 19 to scan the barcode attached to the article, the article registration unit 37 accepts an input of the article code and article price of each article from the code symbol and carries out sales registration of the article. When the sales registration of all the articles is finished and a current total key on the keyboard 13 is pressed, the article registration unit 37 calculates the amount of purchase of all the articles (ACT 2).

After the sales registration of all the articles is finished, the clerk uses the scanner 19 to scan the barcode attached to the point voucher 3 (see FIG. 1) received from the customer. The point accepting unit 36 accepts an input of the number of points on the point voucher 3 from the scanned code symbol (ACT 3).

Then, the extraction unit 38 extracts the point return rate corresponding to the member rank accepted in ACT 1 from the return rate setting table 41 (see FIG. 5) (ACT 4). The calculation unit 39 multiplies the number of points accepted in ACT 3 by the point return rate extracted in ACT 4 in accordance with the above equation (1) and thus calculates the amount of point return (ACT 5). The calculation unit 39 also subtracts the amount of return based on the point voucher calculated in ACT 5 from the amount of purchase of all the articles calculated in ACT 2 and thus calculates the amount requested after the discount with the point voucher 3 (ACT 6). Then, the processing ends.

As described above, according to this embodiment, the amount of return on the point voucher 3 can be changed according to the member rank as of when the point voucher is used. Thus, the member can increase the amount of return by raising the member rank even after the point voucher 3 is issued. Therefore, there is an advantage that consumer appetite of the customer can be increased.

As shown in FIG. 1, since the expiration date is provided on the point voucher 3, the customer wants to have a discount with a higher point return rate by raising the member rank before the expiration date. Therefore, there is an advantage that customer attraction to the store is improved.

The point accepting unit 36 may accept an input of the expiration date of the point voucher 3 from the scanned code symbol. In this case, the point accepting unit 36 accepts an input of the number of points on the point voucher 3 only if the current date is before the accepted expiration date. On the other hand, if the current date is after the expiration date, the point accepting unit 36 does not accept an input of the number of points that is read, and the POS terminal 1 may display that the point voucher 3 is already expired, on the clerk-side display 15.

In the above example, the member rank accepting unit 35 reads the member rank from the customer's member card 2, using the card reader 11. However, the input of the member rank is not limited to this example. As another example, the POS terminal 1 may have an RFID reader, then read member information from the customer's portable electronic terminal with an RFID function or member card with an RFID function, and thus accept an input of the customer's member rank. Alternatively, an input of the member rank may be accepted via a key input on the keyboard 13.

Similarly, though the point accepting unit 36 accepts the input of the number of points from the code symbol on the point voucher 3 in the above example, the input of the number of points is not limited to this example. As another example, the POS terminal 1 may have an RFID reader and accepts the number of points held by the customer from the customer's portable electronic terminal with an RFID function or member card with an RFID function.

In the POS terminal 1 according to this embodiment, the setting content of the return rate setting table 41 is incorporated in the HDD 40 in advance. However, if the return rate corresponding to the member rank is to be changed, this setting content can be changed under the control of the control unit 31. Also, the store server can access the POS terminal 1 via the LAN (neither the store server nor the LAN being shown) and update the setting content.

In the above example, the return rate setting table 41 is stored in the HDD 40 of the POS terminal 1. However, the storage of the return rate setting table is not limited to this example. As another example, the return rate setting table 41 may be stored in a storage unit of the store server and the extraction unit 38 may access the store server and extract the point return rate.

### Second Embodiment

In a second embodiment, if the member rank as of when the point voucher is used is raised from the member rank as of when the point voucher is issued, bonus points are added.

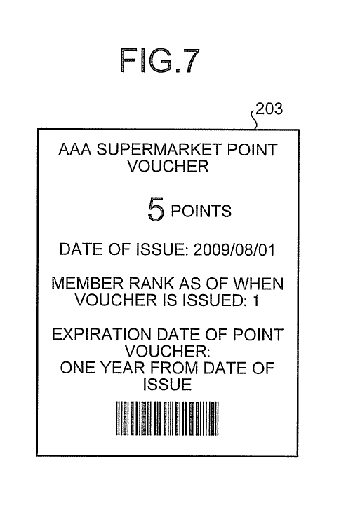

FIG. 7 is a plan view showing an example of a point voucher 203 used in this embodiment. The store issues the point voucher 203 showing the member rank as of when the point voucher 203 is issued, using a POS terminal, a point voucher issue machine or the like as in the previous embodiment. The code symbol attached to the point voucher 203 contains information about the member rank as of when the point voucher 203 is issued.

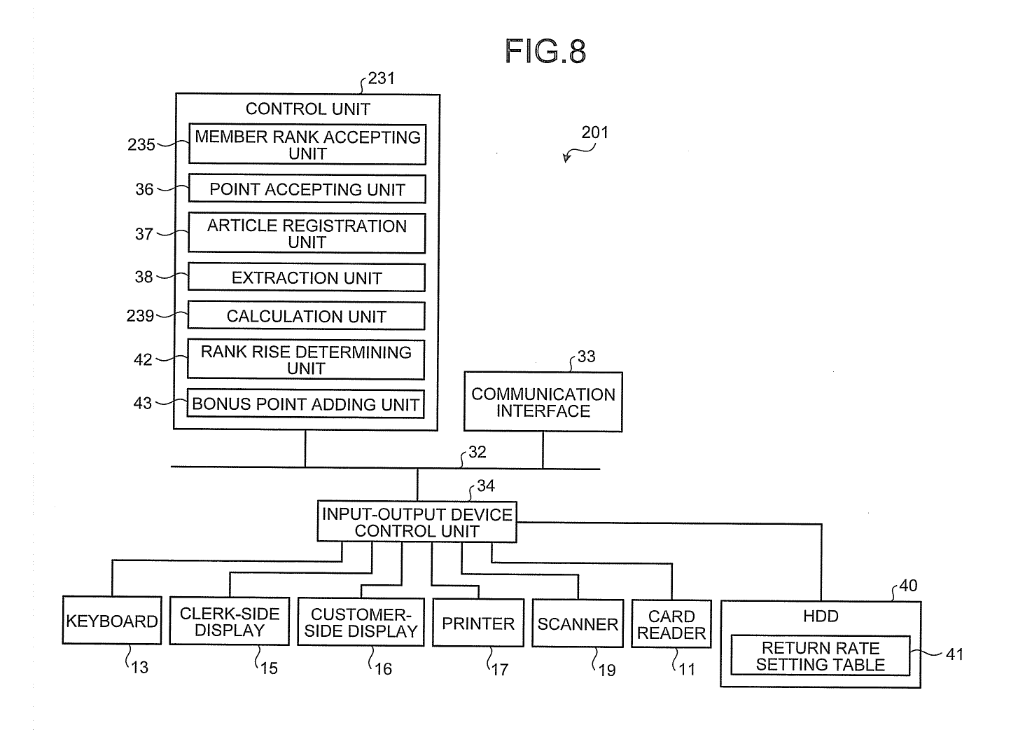

FIG. 8 is a block diagram showing the functional configuration of a POS terminal 201 according to the second embodiment. As shown in FIG. 8, the POS terminal 201 has a control unit 231. The control unit 231 mainly has a member rank accepting unit 235, the point accepting unit 36, the article registration unit 37, the extraction unit 38, a calculation unit 239, a rank rise determining unit 42, and a bonus point adding unit 43. The same parts in the configuration as those in the first embodiment are denoted by the same reference numerals and will not be described further in detail here.

As the scanner 19 scans the code symbol such as a barcode (see FIG. 7) or two-dimensional code on the point voucher 203 which the clerk receives from the customer, the member rank accepting unit 235 accepts an input of the customer's member rank as of when the point voucher 203 is issued, from the code symbol that is read. The input of the member rank as of when the voucher is issued may also be accepted when the clerk inputs the member rank as of when the voucher is issued which is described on the point voucher 203, via the keyboard 13. As an example, as the scanner 19 scans the code symbol on the point voucher 203 shown in FIG. 7, the member rank accepting unit 235 accepts an input that the member rank as of when the voucher is issued is 1.

The rank rise determining unit 42 determines whether the current member rank as of when the customer uses the point voucher 203 is raised from the member rank as of when the point voucher 203 is issued. That is, if the member rank as of when the point voucher 203 is issued is 1 (see FIG. 7) and the member rank as of when the point voucher is used is 2 (see FIG. 3), the rank rise determining unit 42 determines that the member rank is raised.

If the member rank is raised, the bonus point adding unit 43 adds a predetermined number of bonus points to the number of points accepted by the point accepting unit 36 from the member card 2.

For example, if 0.5 points are uniformly added as the number of bonus points, 0.5 points are added to 5 points on the point voucher 203 (see FIG. 7) and the total number of points, that is, 5.5 points, are available for return.

The calculation unit 239 multiplies the total number of points as a result of adding the bonus points to the number of points accepted by the point accepting unit 36, by the point return rate extracted by the extraction unit 38, and thus calculates the amount of return on the point voucher 203.

Amount of return on point voucher=(number of points+bonus point)×point return rate (2)

To calculate the amount of return, the right side of equation (2) may be multiplied by an appropriate constant or variable.

Specifically, if the number of points accepted by the point accepting unit 36 is 5 points, then 50 bonus points are added and the point return rate extracted by the extraction unit 38 is a multiplication factor of 1.2, the calculation unit 239 calculates the amount of return on the point voucher 203 as (5 points+0.5 points)×1.2=6.6 dollars according to the above equation (2).

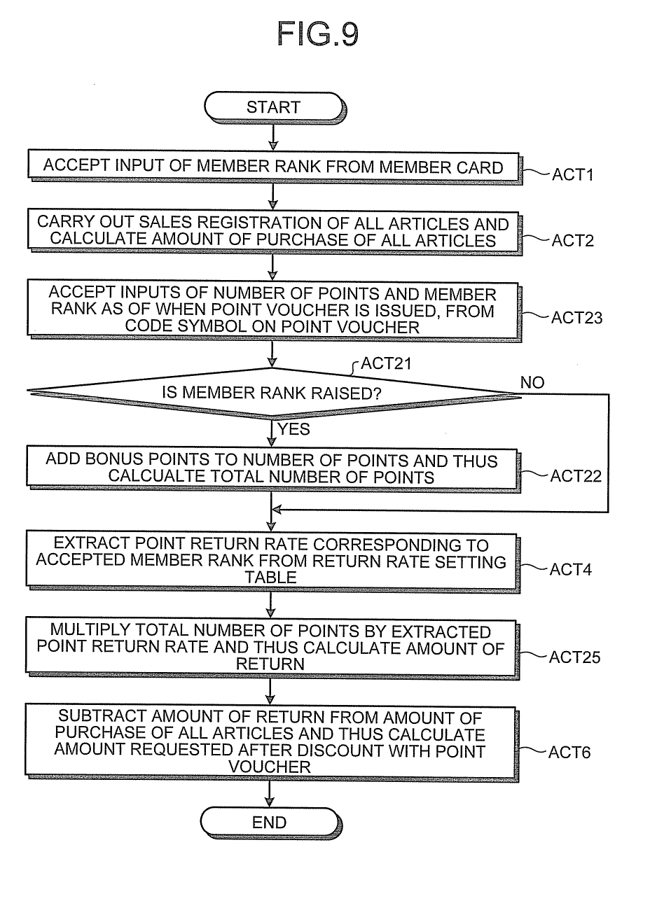

Next, the procedures to calculate the amount of return on the point voucher 203 will be described. FIG. 9 is a flowchart illustrating the procedures to calculate the amount of return on the point voucher 203, carried out by the POS terminal 201. The same procedures as those described in FIG. 6 are denoted by the same reference numerals and will not be described further in detail here.

After the sales registration of all the articles is finished, the clerk uses the scanner 19 to scan the barcode attached to the point voucher 203 (see FIG. 7) received from the customer. The point accepting unit 36 accepts an input of the number of points on the point voucher 203 from the scanned code symbol (ACT 23). The member rank accepting unit 235 accepts an input of the customer's member rank as of when the point voucher 203 is issued, from the scanned code symbol (ACT 23).

The rank rise determining unit 42 determines whether the current member rank as of when the information is read in ACT 1 is raised from the member rank as of when the point voucher 203 is issued that is scanned in ACT 23 (ACT 21).

If the rank is raised (Yes in ACT 21), the bonus point adding unit 43 adds bonus points (for example, 0.5 points) to the number of points accepted in ACT 23 and thus calculates the total number of points (ACT 22). Meanwhile, if the rank is not raised (No in ACT 21), the processing shifts to ACT 4.

The calculation unit 239 multiplies the total number of points calculated in ACT 22 by the point return rate extracted in ACT 4 in accordance with the above equation (2) and thus calculates the amount of return (ACT 25).

As described above, according to the second embodiment, bonus points are added if the member rank is raised from when the point voucher 203 is issued. Therefore, the customer's consumer appetite can be increased.

In the above example, the number of bonus points is uniform. However, the number of bonus points is not limited to this example. As another example, the number of bonus points may be changed according to the number of ranks the member rank is raised. That is, the rank rise determining unit 42 determines how many ranks the member rank is raised compared to when the point voucher 203 is issued, that is, the number of ranks the member rank is raised. The bonus point adding unit 43 adds bonus points according to the number of ranks the member rank is raised. Thus, the customer's appetite for rise in rank can be aroused.

The program executed in the sales data processing apparatus according to the embodiments is provided in the form of being incorporated in the ROM or the like in advance. The program executed in the sales data processing apparatus according to the embodiments may also be provided by being recorded in a computer-readable recording medium such as a CD-ROM, FD (flexible disk), CD-R, or DVD (digital versatile disk) as a file in an installable format or an executable format. Moreover, the program executed in the sales data processing apparatus according to the embodiments may be stored on a computer connected to a network such as the Internet and then downloaded and provided via the network. Also, the program executed in the sales data processing apparatus according to the embodiments may be provided or distributed via a network such as the Internet.

The program executed in the sales data processing apparatus according to the embodiments has a module configuration including the above-described units (the member rank accepting unit 35 or 235, the point accepting unit 36, the article registration unit 37, the extraction unit 38, the calculation unit 39 or 239, the rank rise determining unit 42, and the bonus point adding unit 43). As actual hardware, the CPU (processor) reads out the program from the ROM and executes the program. Thus, the above units are loaded on a main storage device. The member rank accepting unit 35 or 235, the point accepting unit 36, the article registration unit 37, the extraction unit 38, the calculation unit 39 or 239, the rank rise determining unit 42, and the bonus point adding unit 43 are created on the main storage device.

1. A sales data processing apparatus comprising:
a member rank accepting unit which accepts an input of a member rank of a customer as of when a point voucher is used;
a point accepting unit which accepts an input of a number of points on the point voucher;
an extraction unit which extracts, from a storage unit which stores a point return rate defining how much should be returned in dollars for one point corresponding to a member rank, the point return rate corresponding to the member rank accepted by the member rank accepting unit; and
a calculation unit which calculates an amount of return on the point voucher on the basis of the number of points accepted by the point accepting unit and the point return rate extracted by the extraction unit.

2. The apparatus of claim 1, wherein the member rank accepting unit further accepts the member rank of the customer as of when the point voucher is issued, from the point voucher, and
the apparatus further comprises:
a rank rise determining unit which determines whether the member rank as of when the point voucher is used is raised from the member rank as of when the point voucher is issued; and
a bonus point adding unit which adds bonus points to the number of points accepted by the point accepting unit if the member rank is raised.

3. The apparatus of claim 2, wherein the calculation unit multiplies a total number of points as a sum of the number of points and the bonus points by the point return rate and thus calculates the amount of return on the point voucher.

4. The apparatus of claim 2, wherein the rank rise determining unit determines how many ranks the member rank is raised from when the point voucher is issued, and
the bonus point adding unit adds the bonus points corresponding to the number of ranks the member rank is raised, to the number of points.

5. The apparatus of claim 1, wherein a predetermined expiration date is provided on the point voucher, and
the point accepting unit further accepts an input of the expiration date, and accepts the input of the number of points on the point voucher only if the current date is before the accepted expiration date.

6. The apparatus of claim 1, wherein the member rank accepting unit accepts the input of the member rank via communication using RFID.

7. The apparatus of claim 6, wherein the member rank accepting unit accepts the input of the member rank from a customer's portable electronic terminal having an RFID function.

8. The apparatus of claim 1, wherein the point voucher stores the number of points as a code symbol, and
the point accepting unit accepts the input of the number of points on the point voucher by scanning the code symbol.

9. The apparatus of claim 1, wherein the calculation unit multiplies a product of the number of points and the point return rate by a constant or a variable and thus calculates the amount of return on the point voucher.

10. A sales data processing method comprising:
in a sale data processing apparatus,
a member rank accepting unit accepting an input of a member rank of a customer as of when a point voucher is used;
a point accepting unit accepting an input of a number of points on the point voucher;
an extraction unit extracting, from a storage unit which stores a point return rate defining how much should be returned in dollars for one point corresponding to a member rank, the point return rate corresponding to the member rank accepted by the member rank accepting unit; and
a calculation unit calculating an amount of return on the point voucher on the basis of the number of points accepted by the point accepting unit and the point return rate extracted by the extraction unit.
